(19) United States
(12) Patent Application Publication
(10) Pub. No.: US 2010/0103666 A1
(43) Pub. Date: Apr. 29, 2010

(54) LED LAMP BULB STRUCTURE

(76) Inventors: Kun-Jung CHANG, Kaohsiung County (TW); Ching-Yuan Juan, Kaohsiung County (TW); Kuo-Chun Lin, Kaohsiung County (TW); Ching-Huang Juan, Kaohsiung County (TW)

Correspondence Address: Muncy, Geissler, Olds & Lowe, PLLC, P.O. BOX 1364, FAIRFAX, VA, 22038-1364, US

(21) Appl. No.: 12/259,698

(22) Filed: Oct. 28, 2008

(51) Int. Cl. F21V 29/00

(52) U.S. Cl. 362/234

(57) ABSTRACT

An LED lamp bulb structure is disclosed, in which a lamp controller is installed inside a lamp head and the bottom surface of the lamp controller is fixed by an upper cover. At the bottom surface of the upper cover, a heat dispersing fin set, which has at least one heat conducting tube installed therein, and a lower cover are fixed. Furthermore, a bulb housing, which has a tray mounted therein, is screwed around the peripheral edge of the lower cover, and at the bottom of the tray, plural LED lamp sets corresponding to plural heat conducting tubes are outwardly extended. Therefore, the heat produced by the LED lamp sets can have a heat exchange through plural heat conducting tubes and the heat dispersing fin set for achieving a better heat dispersing effect and for more effectively dispersing the heat.

### FIELD OF THE INVENTION

The present invention is related to an LED lamp bulb structure, and more particularly to an LED lamp bulb structure which can disperse heat more efficiently and more rapidly.

### BACKGROUND OF THE INVENTION

Owing to very little energy consumption during operation, LED bulbs have already in place of conventional incandescent lamps in many products, such as decoration lamps, advertisement signs or traffic signs.

However, although the LED lamp 10 can be lit up with very little power supply, the temperature still will become higher when illumination, so that for facilitating replacement, usually, a protection shell 11 (as shown in FIG. 1) is mounted around the LED lamp. Although the protection shell 11 can be held by the consumer as replacing the LED lamp 10, it also encapsulates the heat energy therein and causes a worse heat dispersing, thereby the LED lamp 10 is easily damaged and the life time thereof is short.

Furthermore, for solving the problem of poor heat dispersing capability as described above, another kind of structure is developed, in which an LED lamp 20 is fixed under a heat conducting plate 22, and on the other side of the heat conducting plate 22, heat sinks 21 spaced at intervals are combined therewith (as shown in FIG. 2). When operation, the heat produced by the LED lamp 20 can be absorbed by the heat conducting plate 22 and then transmitted to heat sinks 21 for dispersing. However, after heating a period of time, a bake effect might appear to all heat sinks 21, and easily, the limitation of contact conduction provided by the heat sinks 21 will be reached and the heat will stay around the heat sinks 21, thereby increasing the difficulty to disperse the heat. Therefore, the life time of LED lamp 20 also might be reduced.

### SUMMARY OF THE INVENTION

The object of the present invention is to provide a heat dispersing structure in which plural heat conducting tubes and heat sinks are used to perform heat exchange for achieving a better heat dispersing effect and for more effectively dispersing the heat.

For achieving the object described above, the present invention provides an LED lamp bulb structure, in which a lamp controller is installed inside a lamp head and the bottom surface of the lamp controller is fixed by an upper cover. At the bottom surface of the upper cover, a heat dispersing fin set, which has at least one heat conducting tube installed therein, and a lower cover are fixed. Furthermore, a bulb housing, which has a tray mounted therein, is screwed around the peripheral edge of the lower cover, and at the bottom of the tray, plural LED lamp sets corresponding to plural heat conducting tubes are outwardly extended.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional drawing showing a conventional LED lamp;

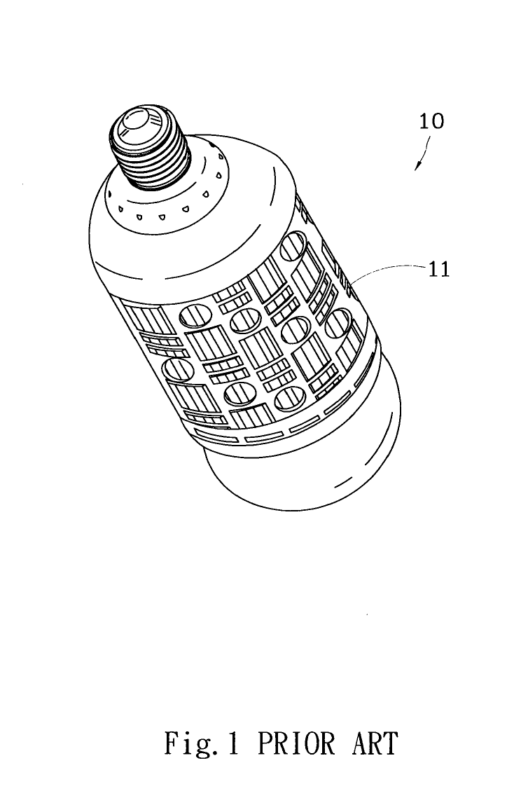

FIG. 2 is a three-dimensional drawing showing another conventional LED lamp;

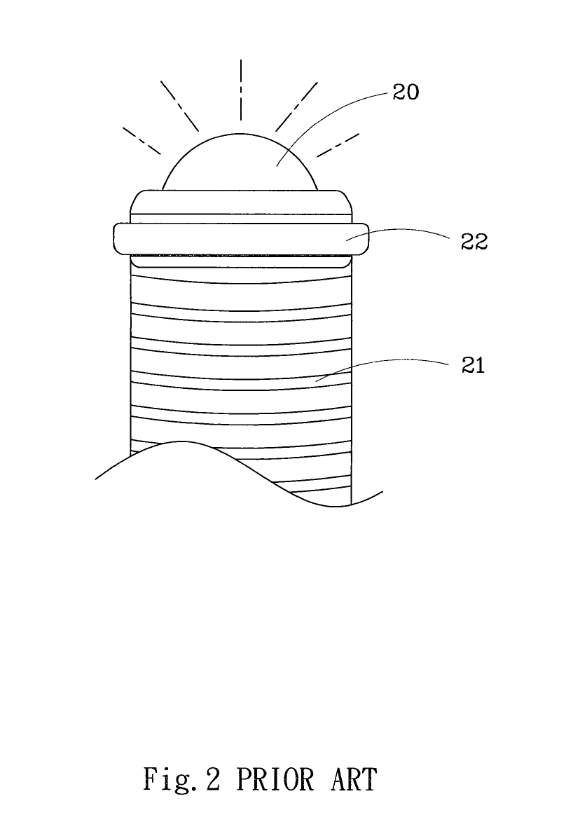

FIG. 3 is a three-dimensional decomposition drawing of the present invention;

FIG. 4 is a three-dimensional drawing showing the appearance of the present invention;

FIG. 5A is an upward view showing the present invention;

FIG. 5B is a sectional view of line 5B-5B in FIG. 5A; and

FIG. 6 is a three-dimensional view showing the upper cover of the present invention.

### DESCRIPTION OF THE PREFERRED EMBODIMENT

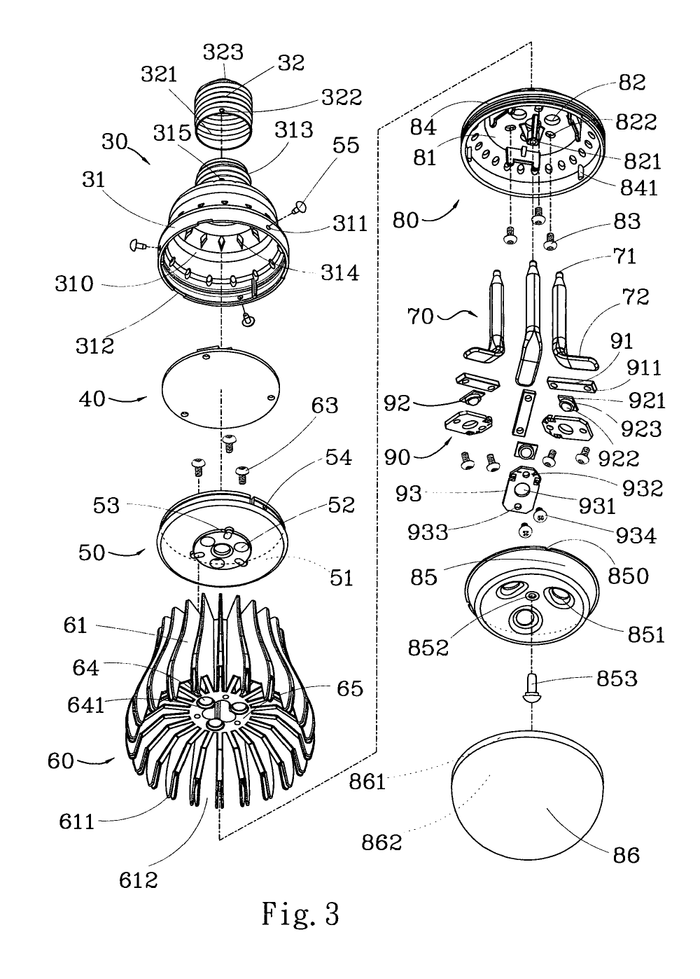

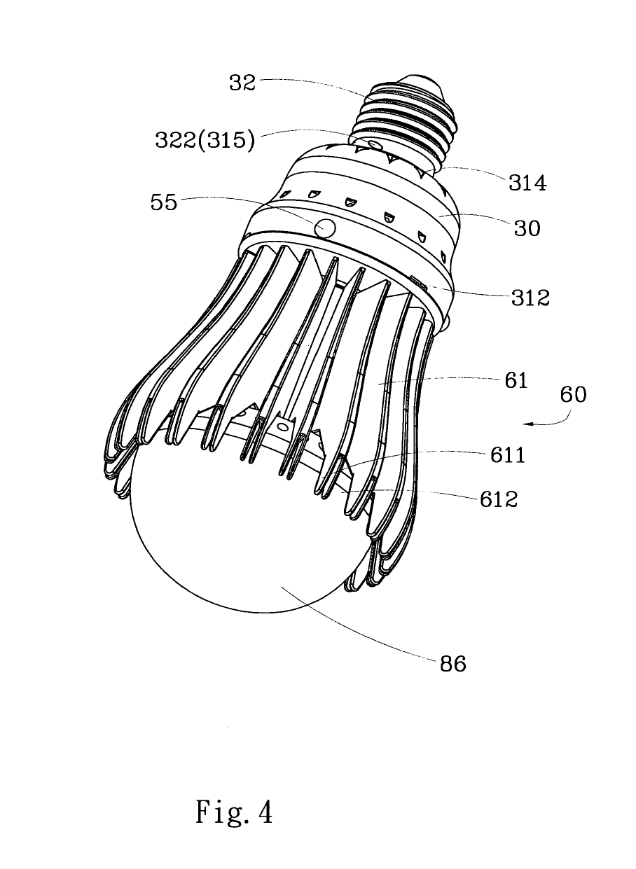

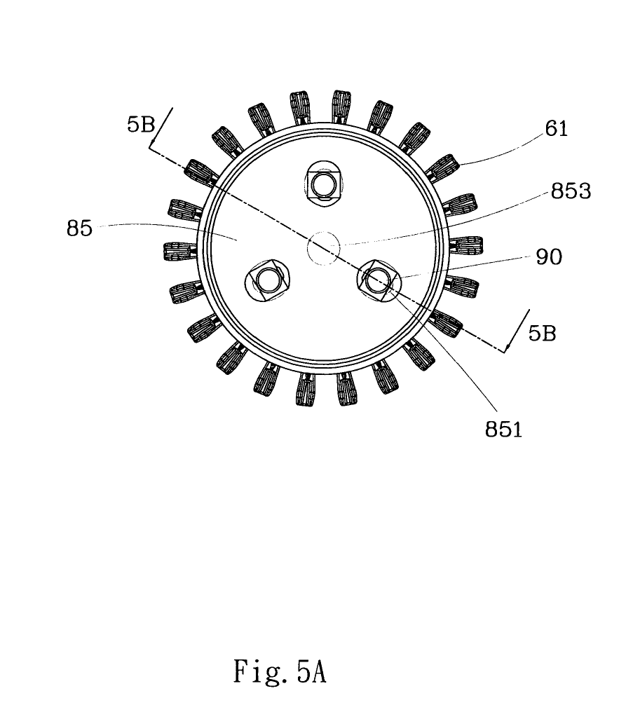

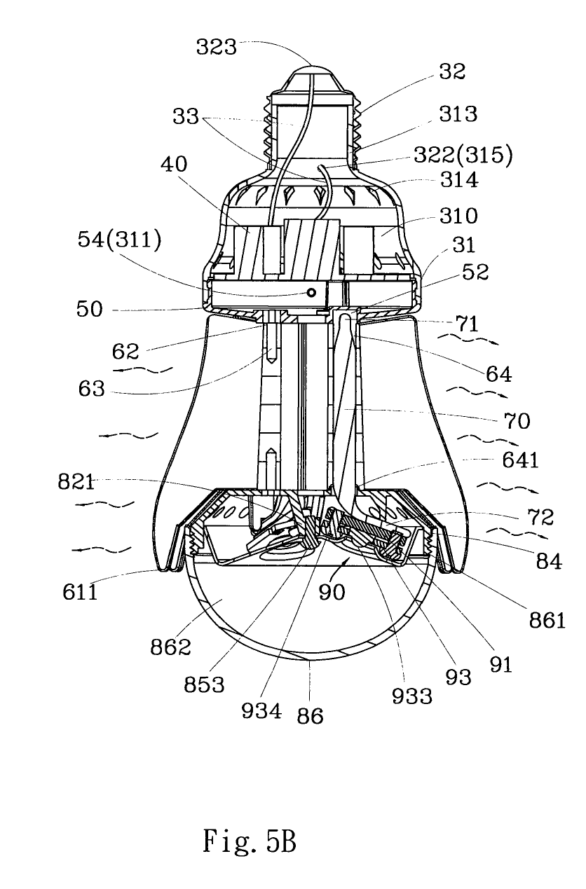

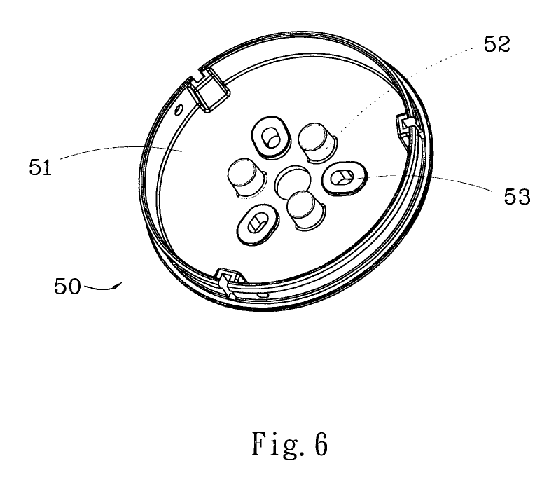

Please refer to FIG. 3, FIG. 4, FIG. 5B and FIG. 6. The LED lamp bulb structure of the present invention includes a lamp head 30, a lamp controller 40, an upper cover 50, a heat dispersing fin set 60, plural heat conducting tubes 70, a lower cover 80, and plural LED lamp sets 90, wherein:

The lamp head 30 includes a main lamp base 31, a conductive shell 32, and plural conducting wires 33. The main lamp base 31 has an inner accommodating space 310 for fixedly mounting the lamp controller 40 and the upper cover 50, plural fixing holes 311 and plural disengaging slots 312 mounted around the lower portion of the main lamp base 31, a screw portion 313 located at the top portion of the lamp base 31, plural ventilating holes 314 mounted at an outer edge near the screw portion 313, and a wiring hole 315 mounted at the lower end of the screw portion 313. The conductive shell 32 has inner thread 321 mounted inside for assembling with the screw portion 313 at the top portion of the lamp base 31, a wiring hole 322 mounted at the lower portion of the inner thread 321 and corresponding to the wiring hole 315 at the lower portion of the screw portion 313, and an electrode 323 located at the top of the inner screw 321. As assembling, one end of a conducting wire 33 is penetrated through the wiring holes 315, 322 and welded on the conductive shell 32 for forming an electric connection, and one end of the other conducting wire 33 is welded on the electrode 323 for forming an electric connection.

The lamp controller 40 is fixed in the inner accommodating space 310 of the main lamp base 31 and is welded on the other ends of both conducting wires 33, so as to form the electric connection between the lamp controller 40 and the conductive shell 32.

The upper cover 50 is sleeved in the lower side of the inner accommodating space 310 of the main lamp base 31 and is rejected to the bottom surface of the lamp controller 40. The upper cover 50 has an inwardly indented chamber 51 including at least an indentation 52 and plural perforations 53 respectively mounted at the center portion of the inwardly indented chamber 51, and locking holes 54 mounted around the inwardly indented chamber 51. Therefore, through penetrating the fixing hole 311 of the main lamp base 31 and the locking hole 54 by a fixing element 55, such as a tenon, the upper cover 50 can be fixed.

The heat dispersing fin set 60 is a heat dispersing integration, whose upper portion is narrower than the lower portion and which is composed of plural heat dispersing fins 61, wherein through screwing the fixing element 63, such as screw, to at least one locking hole 62, which is corresponding to the perforation 53 on the upper cover 50, the heat dispersing fin set 60 can be fixed to the bottom surface of the cover 50. Penetrating holes 64 corresponding to plural indentations 52 are mounted among plural locking holes 62, and burying holes 641 are respectively mounted at the end of each penetrating hole 64. Furthermore, the ends of plural heat dispersing fins 61 are respectively formed to have a sharp portion 611 for reducing the weight thereof, increasing heat dispersing space and also providing a pleasing appearance. And, intervals 612 are kept among heat dispersing fins 61 for facilitating heat dispersing. In addition, the heat dispersing fin set 60 has an inwardly indented space 65 at the bottom portion thereof for receiving and sleeving the lower cover 80.

Plural heat conducting tubes 70 are penetrated through plural through holes 82 of the lower cover 80, which is located under the heat dispersing fin set 60, and plural penetrating holes 64 at the center of the heat dispersing fin set 60. Here, the number of heat conducting tube 70 can be more than one, and in the preferred embodiment shown, there are three heat conducting tubes 70. Moreover, the heat conducting tube 70 can be solid or hollow. One end of the heat conducting tube 70 is formed to be a protruded bolt portion 71 for rejecting to and fixing in the indentations 52 of the upper cover 50, and the other end is bent to form an outwardly inclined board 72 which can condense the light. Besides, the bottom portion of the outwardly inclined board 72 is used to fix with an LED lamp set 90.

The lower cover 80 is a cylinder body and is fixedly mounted in the inwardly indented space 65 at the bottom of the heat dispersing fin set 60. The lower cover 80 has an inwardly indented chamber 81 in the inner portion thereof and includes through holes 82 mounted thereon corresponding to the penetrating holes 64 of the heat dispersing fin set 60, a fixing seat 821 at the center of the through holes 82, and locking holes 822 mounted among the through holes 82. Through screwing and fixing locking elements 83, such as screws, to the locking holes 822, the lower cover 80 can be fixed at the bottom of the best dispersing fin set 60. Furthermore, an outer screwing portion 84 is formed at the outer peripheral of the lower cover 80 and plural fixing pillars 841 are mounted at the inner side of the lower cover 80. Here, the lower cover 80 is screwed with an inner screwing portion 861 of a bulb housing 86 by the outer screwing portion 84 thereof, in which the bulb housing 86 has frost outer surface and smooth inner surface, and has an upwardly opened chamber 862 for installing a tray 85. The tray 85 is an upwardly opened disc and has plural fixing slots 850 mounted around the top surface corresponding to the fixing pillars 841 at the inner side of the lower portion 84 of the lower cover 80, and further, the tray also has slot holes 851 mounted on the surface near the peripheral edge corresponding to plural heat conducting tubes 70. Besides, at the center of slot holes 851, a perforation 852 is mounted thereon corresponding to the fixing seat 821 of the lower cover 80 and fixed by fixing element 853 such as a tenon.

The LED lamp set 90 is fixedly mounted at the bottom portions of the outwardly inclined boards 72 of plural heat conducting tubes 70 and is protruded out of the bottom surface of the tray 85. The LED lamp set 90 at least includes a heat conducting block 91, an LED lamp 92, and a substrate 93. The heat conducting block 91 is fixedly pasted at the bottom of the outwardly inclined board 72. The LED lamp 92 has a plate 921 located at one side thereof and, and at the other side, a light emitting diode 922 with a protection frame 923 surrounding thereof. And, the substrate 93 is a printed circuit board with circuitry which has a through hole 931 for embedding the LED lamp 92, a serial circuit 932 located at one side thereof for serially connecting with the LED lamp 92 so as to increase brightness, and plural perforations 933 mounted thereon for cooperating with the fixing elements 934, which penetrate into the perforations 933, so as to lock the substrate 93 on the heat conducting block 91. Moreover, the heat conducting block 91 is a metal block with thickness and high heat conductivity for serving as a heat dispersing medium, is pasted at one side of the plate 921 of the LED lamp 92 for dispersing the produced heat, and has plural locking holes 911 mounted thereon for cooperating with the fixing elements 934 so as to lock and connect the heat conducting block 91 to the substrate 93.

Please refer to FIG. 4, FIG. 5A and FIG. 5B. When assembling, the lamp controller 40 is installed inside the lamp head 30 and the bottom surface thereof is fixed by the upper cover 50. At the bottom surface of the upper cover 50, a heat dispersing fin set 60, which has at least one heat conducting tube 70 installed therein, and a lower cover 80 are fixed. A bulb housing 86, which has a tray 85 mounted therein, is screwed around the peripheral edge of the cover 80. At the bottom of the tray 85, plural LED lamp sets 90 corresponding to plural heat conducting tubes 70 are outwardly extended. In view of the structure described above, when operating the LED lamp set 90 which is mounted at the bottoms of the outwardly inclined boards 72 at one ends of plural heat conducting tubes 70, as shown in FIG. 5B, through the heat exchange performed by plural heat conducting tubes 70 and the heat dispersing fin set 60, the produced heat with high temperature can be conducted by plural heat conducting tubes 70 to the heat dispersing fin set 60 and dispersed by each heat dispersing fin 61, so as to achieve a more efficient heat dispersing.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp bulb structure, comprising:
a lamp head, including a main lamp base and a conductive shell and having an inner accommodating space in the main lamp base;
a lamp controller, fixed in the lamp head;
an upper cover, sleeved at the lower end of the inner accommodating space of the main lamp base and fixed to the bottom portion of the lamp controller, and having an inwardly indented chamber with plural indentations;
a heat dispersing fin set, which is a heat dispersing integration composed of plural heat dispersing fins and fixed at the bottom surface of the upper cover, and which has an inwardly indented space at the bottom thereof, plural penetrating holes mounted at the central portion thereof corresponding to plural indentations, and burying holes respectively mounted at the end of each penetrating hole, and
a lower cover, which is fixedly mounted in the inwardly indented space at the bottom of the heat dispersing fin set, which has an inwardly indented chamber in the inner portion thereof with plural through holes mounted thereon corresponding to plural indentations, and whose outer surface is screwed with a bulb housing, which accommodates a tray therein;
plural heat conducting tubes, penetrated through the through holes of the lower cover, which is located under the heat dispersing fin set, and plural penetrating holes, wherein one end of the heat conducting tube is formed to be a protruded bolt portion for rejecting to the indentation of the upper cover, and the other end is bent to form an outwardly inclined board; and
plural LED lamp sets, fixedly mounted at the bottom portions of the outwardly inclined boards of plural heat conducting tubes and protruded out of the bottom surface of the tray.

2. The structure as claimed in claim 1, wherein the lower cover is a cylinder body having plural through holes mounted thereon, fixing pillars mounted at the lower portion thereof corresponding to fixing slots, which are used to fix the tray, and a fixing seat at the center of the inwardly indented space for fixing the tray.

3. The structure as claimed in claim 1, wherein the ends of plural heat dispersing fins are respectively formed to have a sharp portion, and an interval is formed between each two heat dispersing fins.

4. The structure as claimed in claim 1, wherein the bulb housing has an upwardly opened chamber for installing the tray, and the bulb housing has frost outer surface and smooth inner surface, so as to tone down the light and avoid from scattering.

5. The structure as claimed in claim 1, wherein the tray is an upwardly opened disc and has slot holes mounted at the surface near the peripheral edge corresponding to plural heat conducting tubes, which are formed to be solid or hollow tubes.

6. The structure as claimed in claim 1, wherein the LED lamp set comprises at least one heat conducting block pasted at the bottom of the outwardly inclined board, an LED lamp located the bottom of the heat conducting block, and a substrate locked with the heat conducting block, wherein the substrate is a printed circuit board with circuitry which has plural through holes for embedding LED lamp, and a serial circuit located at one side thereof for serially connecting with the LED lamp.

7. The structure as claimed in claim 1, wherein the LED lamp has a plate located at one side thereof, and at the other side, a light emitting diode with a protection frame surrounding thereof.

8. The structure as claimed in claim 1, wherein the lower portions of the screw portion and the conductive shell both have a wiring hole respectively mounted thereon, and one end of a conducting wire is respectively penetrated through the wiring hole at the bottom end of the screw portion and the wiring hole of the conductive shell, and welded on the conductive shell for forming an electric connection.

9. The structure as claimed in claim 1, wherein the main lamp base has disengaging slots for facilitating the disengagement of the lamp controller.
